(19) United States
(12) Patent Application Publication
(10) Pub. No.: US 2010/0287482 A1
(43) Pub. Date: Nov. 11, 2010

(54) Method, system, and software for the production of electronic newsletters

(76) Inventors: Christopher Chapin, San Diego, CA (US); Henry Eisenson, San Deigo, CA (US)

Correspondence Address: Henry Eisenson, 3368 Governor Drive, Suite-273, San Diego, CA, 92122, US

(21) Appl. No.: 12/799,125

(22) Filed: Apr. 17, 2010

Related U.S. Application Data
(60) Provisional application No. 61/215,648, filed on May 8, 2009.

(51) Int. Cl. G06F 3/048; G06F 17/00; G06F 15/16

(52) U.S. Cl. 715/752; 715/762; 715/810; 709/206

(57) ABSTRACT

An interactive online document construction system that enables a user to assemble email newsletters by selecting content from repositories of information and images.

The present invention claims the benefit of priority of U.S. Provisional Application for Patent No. 61/215,648, with a filing date of 8 May 2009 by Christopher Chapin, content of which is incorporated herein.

### FIELD OF THE INVENTION

The present invention relates to the field of newsletter communication sent by business professionals to their clients via the internet.

### BACKGROUND OF THE INVENTION

The production and mailing of print media has become too costly for many business professionals, yet the failure of brokers and agents to maintain communication with clients is regarded as a costly error. Many industry professionals have turned to the internet as an economical replacement for print media, but whether the communication is print-on-paper or electronic, the repetitive design, construction, and preparation of written content of such messages is time-consuming, often requires skills that an otherwise-competent professional may not have, and competes for budget with other advertising. The advent of the internet has seen the emergence of many companies and projects that seek to facilitate internet newsletter preparation and management processes, making them easier to manage, less time-consuming, and more economical.

However, known internet newsletter projects focus upon selection and acquisition of mailing lists, efficient management of those lists, the emailing process itself, and then the capture and tabulation of data describing detected recipient actions. The creative tasks of preparing content and, often, of designing layout remain the responsibility of the sales executive, agent, or broker generating the newsletter.

The business that seeks to send newsletters to prospective and existing clients must first settle on a layout or design, then populate that design with content that is meaningful, entertaining, and inviting to the recipient. Known internet newsletter generation and management systems generally depend upon the creative skills of the agent or broker.

### DESCRIPTION OF THE PRIOR ART

Various internet newsletter management companies assist the originator in disseminating the electronic document, and then capturing of statistics regarding the actions taken by recipients. These are well-understand functions of products and services comprising prior art.

Published application 20080147816 by Damm describes a tracking mechanism using embedded content, but ignores the generation of content. The present invention is differentiated from this invention and others like it by virtue of its unique ability to produce content by means of a point-and-click selection method.

Published application 20050268212 by Dagel describes a system for assisting an originator in designing a newsletter, but still requires creativity on the part of the originator of the newsletter. Moreover, that invention does not detect or prohibit redundant mailings.

Issued U.S. Pat. No. 6,304,849 by Uecker teaches a newsletter process for pharmaceutical companies in which the product label and newsletter itself are integrated. This is an effective communication medium as the consumer reading the label must as well see the newsletter, which is promotional. The present invention is differentiated from this invention and others like it by virtue of its unique ability to assist the originator in constructing message content of the newsletter using a point-and-click selection method.

Issued U.S. Pat. No. 7,698,719 by Evans, et al, teaches a computerized mechanism by which the user can construct an advertisement from selectable lists of components. The present invention is differentiated from this invention and others like it by virtue of its unique ability to construct an educational newsletter using a point-and-click selection method.

Known systems operating in the marketplace usually provide four basic functions. First, a general layout or design is provided, or can be selected by the originator from a display of alternative layouts. Second, the originator is permitted to upload one or more email address lists to comprise a recipient database. Third, the originator is assisted in disseminating the document to selected lists, using methods, tools, and mechanisms designed to avoid the blocking of unauthorized email advertising (spam). And fourth, known systems provide methods and tools by which the originator can determine the effectiveness of the mailing, by tracking the portions of the mailing that are read by the recipient, links that are followed, and other techniques.

Known interne newsletter systems do at least those four well, with little to differentiate one such service from another except for price, making the newsletter generation industry a commodity business. Any business method that provides new functionality or efficiency improvements will be unique in the newsletter marketplace.

Known systems and companies require creativity and skills on the part of the originator, so time and effort must be expended to actually generate and organize the content of each mailing. Such content usually includes messages that are specific to the originator's business, describe the industry in which the originator does business, and appeals to the market of which the recipient is a member. Originators also must try to include elements that capture and retain the attention of the reader. Known internet newsletter systems necessitate generation of such content by the originator, who often does not have the creative skills, knowledge, time, or patience to do those tasks in a professional manner.

Newsletter systems, services, and companies properly manage mailing lists, the dissemination of an originator-created newsletter or a purchased one, and the tracking of the effectiveness of such mailings. They lack the ability to assist the originator in generating email newsletter content.

Other problems with existing newsletter systems will become apparent when the present invention is compared with them and its advantages become obvious.

### OBJECTIVES OF THE INVENTION

In view of the foregoing disadvantages inherent in the known methods, systems, and businesses that assist originators of newsletters with preparation, propagation, management, and tracking of newsletters, the present invention is a clear departure because it provides at least one basic improvement that is otherwise not available: content selection.

The main objective of the present invention is to provide a newsletter system that is not unlike existing systems in the public domain, except for the unique ability to create the actual message. The present invention offers the originator an inventory of selectable content which, by a point-and-click process is automatically assembled into a pertinent, informative, attention-capturing, and effective newsletter.

As an example, an insurance agency is supported by agents and brokers who understand the value of communicating with their client base, but lack time and creative skills required to product newsletters and bulletins. The present invention perfectly suits that community, plus realtors, consultants, attorneys, and other professionals.

Another objective of the present invention is the conservation of time. It is acknowledged that any skilled and creative originator can write and assemble the content of a newsletter, but the objective of the present invention is to achieve similar results in less time, with less effort, and with a lower required level of creative skills.

Another objective of the present invention is to ensure that each newsletter received is novel and unique, and presents fresh information, with no repetition of the content of previous newsletters unless the originator permits it.

Other objects and advantages of the present invention will become obvious to the reader and it is intended that these objects and advantages be within its scope.

To the accomplishment of the above and related objects, this invention may be embodied in the forms illustrated in the accompanying specification and drawings. However, the specification and drawings are illustrative of the basic concepts only; there are many possible configurations and derivatives lying within the intended scope of the invention.

### BRIEF SUMMARY OF THE INVENTION

The present invention is similar to known systems, methods, and businesses that manage electronic newsletters designed to propagate information from the originator to an audience using the medium of the internet. It adds, however, content generation and management.

In addition to known email newsletter generation features such as mailing list, management, propagation, and performance tracking, the present invention provides the originator with inventories of content in several categories from which a selection can be made using an online point-and-click process, and which is then automatically assembled by the present invention into the newsletter design or format determined by the originator.

Inventories of content are generated by the company operating the present invention, purchased from other sources, or produced by contractors to that company.

After paying for a subscription to the service, the originator logs into the service's website and uploads email lists, selects a newsletter format, and selects reports required.

Thereafter, to construct and send a newsletter the originator initially chooses the list(s) to which the new newsletter will be emailed, then selects content by visiting website-provided pages showing choices in various categories; the originator uses a pointing device to make selections.

The originator is given the option of entering (creating) personalized content.

Various prompts are generated by the present invention to ensure a competent result.

The present invention then produces the assembled newsletter and presents it on-screen for approval by the originator.

The present invention then compares the newly-assembled newsletter to previous editions sent to members of the selected list(s), notifies the originator if any duplication exists, and permits the replacement of the duplicate material.

Once the originator has approved the newly-created newsletter, the present invention sends it to the lists designated by the originator, and uses known tracking and reporting methods to report performance to the originator.

Finally, the service generates periodic reports to assist the originator in optimizing his/her newsletters and the overall client communication process.

The value and merit of the present invention, and its ability to reduce the requirement for creative skills on the part of the originator, can be easily recognized by substituting the “originator” with a pseudo-random number generator that makes the selections. The result will still be a meaningful and functional newsletter, with the only human involvement being the generation of content by sources outside of the newsletter production and management system.

### BRIEF DESCRIPTION OF THE SEVERAL VIEWS OF THE DRAWINGS

FIG. 1 provides a graphic depiction of the present invention.

FIG. 2 is a highly simplified flowchart showing decisions and process.

### DETAILED DESCRIPTION OF THE INVENTION

The present invention assists the originator of a newsletter in the construction, propagation, and tracking of electronic newsletters via email. The present invention is comprised of a website, data repositories, and a software engine.

The website component of the present invention is accessed by visitors in the same manner as any website is visited.

The data repository component of the present invention contains subscriber information, subscriber mailing lists, subscriber history (past selections), and content libraries.

Content libraries can include, but are not limited to:
a. Articles, prepared by the service provider, an outside writer/contractor, or other sources.
b. Images, from public domain art or after purchasing rights.
c. Quotations from authoritative or interesting sources, typically within the field of the subscriber's business (i.e. insurance, law, real estate, etc.).
d. Industry and market statistics that are interesting and attention-getting.
e. News from the media—with attribution where required.
f. Humor, typically applicable to the field of the subscriber's business.

The website introduces the present invention to the visitor as a new and efficient method for assembling, sending, and managing email newsletters, and tracking their performance at the recipient end. The website discloses the semi-automated newsletter construction mechanisms of the present invention, which serves to differentiate services employing the present invention from other newsletter system opportunities.

Visitors opting to subscribe will click on a link to a subscription engine that will process a credit card or accept a PayPal payment, collect information from the new subscriber, and establish the subscriber's identity and supporting data in the system database.

The website shows the new subscriber options regarding newsletter format/design, allowing choices that will personalize the result and optimize it for the new subscriber's business and the mailing list(s) to which newsletters will be sent.

Thereafter, the subscriber can visit the website periodically (monthly, weekly, etc.), log in, and execute the newsletter generation process, which consists of:
a. Log in
b. Select the mailing list(s) to which a newsletter is to go
c. Load the selected format/design.
d. Select each of the components that comprise the finished document.
e. Add personal comments if desired.
f. Press the button that says something like “Build My Newsletter,” and check the result.
g. If satisfactory, test the newsletter by allowing the website to mail it to the originator's email address.
h. If the received newsletter is correct, link the newly-produced newsletter to the desired mailing list.
i. If required, the resulting newsletter will be offered to a compliance offer for approval, to ensure no violation of spam regulations.
j. Compare the content of the newly-produced newsletter to content elements sent to list members.
k. If duplication is detected, provide the originator the opportunity to replace the redundant material.
l. Send the newsletter to the selected list(s).
m. Task complete.

At some specified time(s) after the newsletter has been sent, the system implementing the present invention will collect performance data from recipients and report to the originator.

All information broadcasting methods in which the message or document is constructed by means of point-and-click selection of content elements from repositories are considered part of the present invention. All web-based newsletter systems in which that point-and-click content selection is offered are also considered part of the present invention.

### VARIATIONS UPON THE PRESENT INVENTION

The present invention was intended to simplify the construction of electronic newsletters to be disseminated by known methods to email recipients.

The present invention is equally adaptable to the construction of newsletters for printing, where the simplified point-and-click content selection mechanism adds efficiency and reduces preparation time.

The present invention is equally adaptable to the construction of non-newsletter documents, whether for online propagation or printing.

One variation of the present invention simplifies the process. After logging in, the user is presented with a finished newsletter comprised of content elements specified by him as a set of categories (i.e. one joke, one quotation, two images, one article), and optionally presenting an opportunity to reconfigure the content or add commentary to it.

All such variations and adaptations are considered to be within the scope of the present invention.

### Preferred Embodiment

The concept and software of the present invention can be used in non-newsletter applications in which content of a document is selected from point-and-click menus, and in non-internet newsletter (print media) applications.

In its preferred embodiment, the present invention is executed as an industry-specific or market-specific website that provides an opportunity for subscribers to prepare, send, and manage newsletters from an originator (broker, agent) to recipients (clients, customers).

### DETAILED DESCRIPTION OF THE DRAWINGS

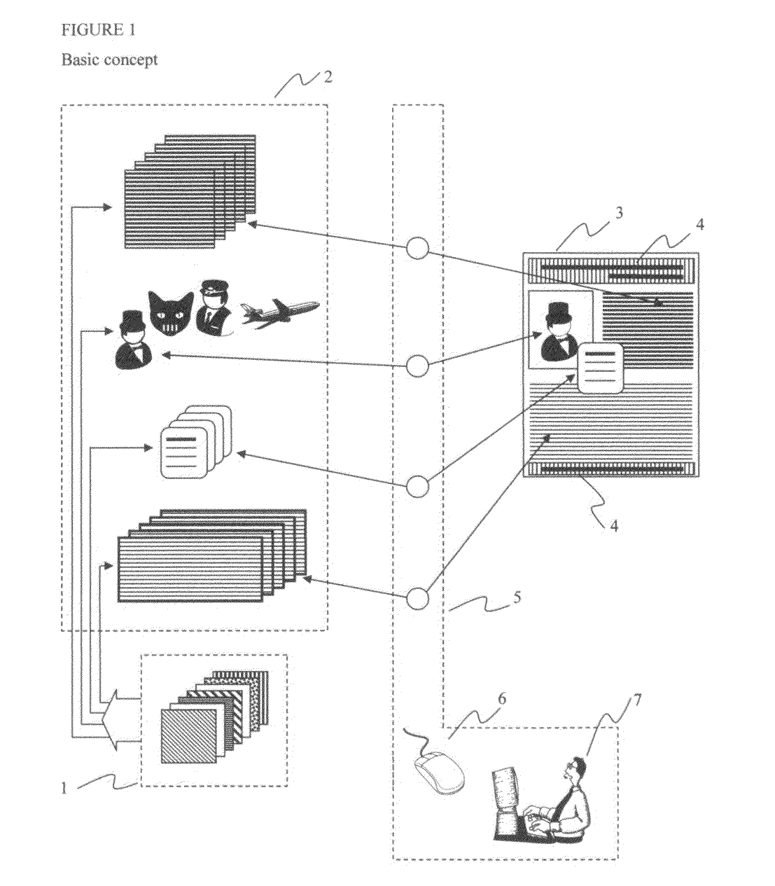

FIG. 1 shows the configuration of the present invention in which a variety of external content sources 1 contribute to a bank of content repositories 2 permitting the automated assembly of a document comprised of a basic format 3 containing a recurring header and footer banners 4, with specific content selection 5 made by a pointing device 6 operated by the document originator 7.

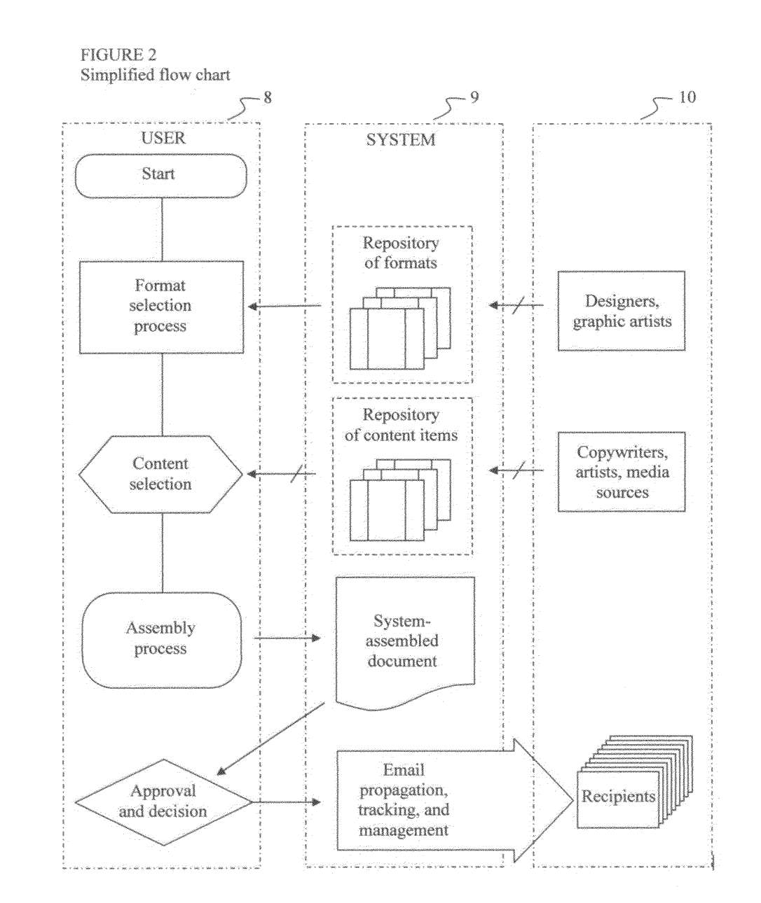

FIG. 2 is a highly simplified flowchart depicting the document-generation process, in which process 8 depicts the user's role in preparing the document with component parts and resources of the system shown in block 9, with support by and propagation to entities outside the process shown in block 10.

We claim:

1. A system, method, software, and graphical user interface that enables a user to select the component parts of a newly-created document from repositories or lists, enabling the assembly of the document without requiring creative skills on the part of the user.

2. The system of claim 1 in which the so-constructed document is an electronic newsletter.

3. The system of claim 1 in which the component parts in said repositories or lists can include articles, humor, images, news releases, statistics, or quotations.

4. A system, method, software, and graphical user interface that enables a user to use a computer to select formats and design elements that define the structure of an internet newsletter.

5. The system of claim 1 in which the selections by the user are automatically assembled into the design of claim 3.

6. The system of claim 4 in which a provision is made permitting the entry of user-generated messages in addition to the system-generated content.

7. The system of claim 5 in which the user can upload lists of email addresses of clients and customers.

8. The system of claim 5 in which the user can specify the lists of email addresses to which a given newsletter construction is to be sent by the system.

9. The system of claim 5 in which the system permits the user to send the resulting document to a single email address, such as that of the user, to be checked for accuracy, before it is broadcast to the mailing list.

10. A newsletter generation system that provides the user with a complete document ready to email, with said document varying from one mailing period to another, and that gives the user the opportunity to add, change, or delete content, thus further reducing the workload required to issue a newsletter.

11. A content-comparing process to ensure novelty of newsletter content seen by recipients, by which the content of a newly-constructed newsletter is compared to the content of newsletters sent previously, with alerts to the user if duplication is detected.
